(19) United States
(12) Patent Application Publication
(10) Pub. No.: US 2026/0302899 A1
(43) Pub. Date: Oct. 1, 2026

(54) ELECTRIC WATER PUMP WITH GROUNDING DEVICE

(71) Applicant: COAVIS, Sejong-si (KR)

(72) Inventors: Seonghwan MOON, Daejeon (KR); Kusung KWON, Daejeon (KR); Hosik SON, Daejeon (KR)

(73) Assignee: COAVIS, Sejong-si (KR)

(21) Appl. No.: 19/573,442

(22) Filed: Mar. 20, 2026

(30) Foreign Application Priority Data
Mar. 27, 2025 (KR) 10-2025-0039324

(51) Int. Cl. H02K 11/40; F04D 13/06

(52) U.S. Cl. CPC H02K 11/40; F04D 13/06

(57) ABSTRACT

Provided is an electric water pump capable of discharging internal electricity to the outside through a grounding device, the electric water pump including: an upper assembly including an impeller; a lower assembly coupled to the upper assembly; and a grounding device in contact with the internal fluid and connected to the outside, wherein the lower assembly includes a stator assembly including a rotor accommodation portion accommodating a rotor and a plurality of coils arranged around a rotation shaft of the rotor in a circumferential direction, and a molding portion surrounding the stator assembly to insulate the plurality of coils, the rotor accommodation portion communicating with the impeller to allow internal fluid to circulate inside the rotor accommodation portion and around the molding portion.

### CROSS-REFERENCE TO RELATED APPLICATIONS

This application claims the benefit of priority under 35 U.S.C. § 119 to Republic of Korea Patent Application No. 10-2025-0039324, filed Mar. 27, 2025, the content of which is incorporated herein by reference in its entirety.

### TECHNICAL FIELD

The following disclosure relates to an electric water pump with a grounding device, and more particularly, to an electric water pump capable of removing internal electricity through a grounding device.

### BACKGROUND

A water pump may be a device for circulating coolant to an engine or a heater for cooling of the engine or heating of the interior. The water pump may be broadly classified into a mechanical water pump and an electric water pump.

The mechanical water pump may be a pump connected to a crankshaft of an engine and driven according to rotation of the crankshaft, and the electric water pump may be a pump driven according to rotation of a motor controlled by a control device.

Here, the electric water pump may be driven by electricity regardless of rotation of the engine, and may thus be easily controlled and easily adjust a flow rate of coolant. Accordingly, a proportion of vehicles to which the electric water pump is applied is currently increasing.

However, in a conventional electric water pump, a rotor may rotate by allowing current to flow through a coil formed around a peripheral portion of the rotor, and a sealing member may be additionally provided or waterproof processing may be performed for each configuration to waterproof configurations around the coil. Accordingly, liquid may become trapped inside and current may thus accumulate, thereby causing electrical noise or adverse influence on electrical components, or the like.

### RELATED ART DOCUMENT

### Patent Document

KR 10-2015-0052436 A (2015.05.14.)

### SUMMARY

An embodiment of the present disclosure is directed to providing an electric water pump capable of discharging internal electricity to the outside through a grounding device.

An embodiment of the present disclosure is directed to providing an electric water pump capable of grounding to the outside while minimizing resistance received by liquid circulating inside a stator assembly.

In one general aspect, an electric water pump includes: an upper assembly including an impeller; a lower assembly coupled to the upper assembly; wherein the lower assembly includes a stator assembly including a rotor accommodation portion accommodating a rotor and a plurality of coils arranged around a rotation shaft of the rotor in a circumferential direction, and a molding portion surrounding the stator assembly to insulate the plurality of coils, the rotor accommodation portion communicating with the impeller to allow internal fluid to circulate inside the rotor accommodation portion and around the molding portion, the electric water pump further comprising a grounding device that is in contact with the internal fluid and is connected to an exterior.

One end of the grounding device may be interposed in the stator assembly.

The grounding device may be interposed in the stator assembly and protrude upward from a lower end portion of the stator assembly.

The stator assembly may include the rotor accommodation portion formed inside the molding portion surrounding the coils, and an outer accommodation portion formed outside the molding portion surrounding the coils, and the grounding device may be interposed in at least one of the rotor accommodation portion and the outer accommodation portion.

The grounding device may include a first grounding device interposed in the rotor accommodation portion, and a second grounding device interposed in the outer accommodation portion.

The electric water pump may include a terminal coupled to a lower portion of the stator assembly and electrically connected to the coils, and the first grounding device and the second grounding device may be connected to the terminal.

The molding portion may further include a passage through which the rotor accommodation portion and the outer accommodation portion communicate with each other.

The first grounding device and the second grounding device may each be formed at a height lower than a lower surface of the passage.

The molding portion may include a seating portion which protrudes toward an inner direction of the rotor accommodation portion and on which a bearing is seated, and the seating portion may be spaced apart from the passage.

The upper assembly may further include a downward protrusion interposed in the outer accommodation portion to a predetermined depth.

Other features and aspects will be apparent from the following detailed description, the drawings, and the claims.

### BRIEF DESCRIPTION OF THE DRAWINGS

FIG. 1 is a side view of an electric water pump according to the present disclosure.

FIG. 2 is a cross-sectional view of the electric water pump according to the present disclosure.

FIG. 3 is an enlarged view of the electric water pump according to the present disclosure.

FIG. 4 is an enlarged view of the electric water pump according to the present disclosure.

FIG. 5 is a cross-sectional view of the electric water pump according to the present disclosure.

### DETAILED DESCRIPTION OF EMBODIMENTS

Hereinafter, the technical spirit of the present disclosure is described in more detail with reference to the accompanying drawings. Prior to the description, terms and words used in the specification and claims should not be construed as general or dictionary meanings, and should be construed as meanings and concepts consistent with the spirit of the present disclosure, based on the principle that the inventors may appropriately define the concepts of the terms to describe their inventions in the best mode. Therefore, the configurations described in the embodiments and drawings of the present disclosure are merely the most preferred embodiments and do not represent the entire scope of the present disclosure. Accordingly, the present disclosure should be construed as including all modifications and alternatives that may be made within the spirit and scope of the present disclosure at the time of filing this application.

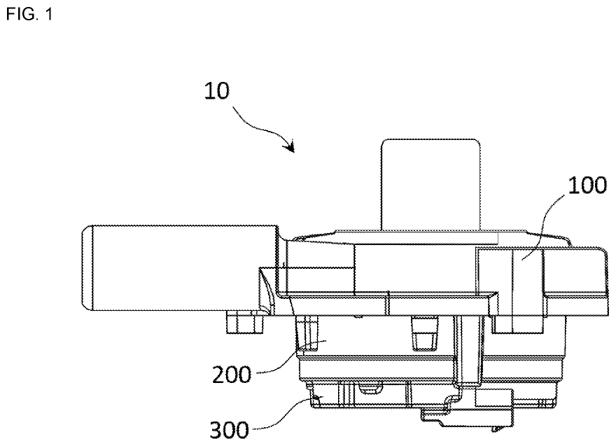

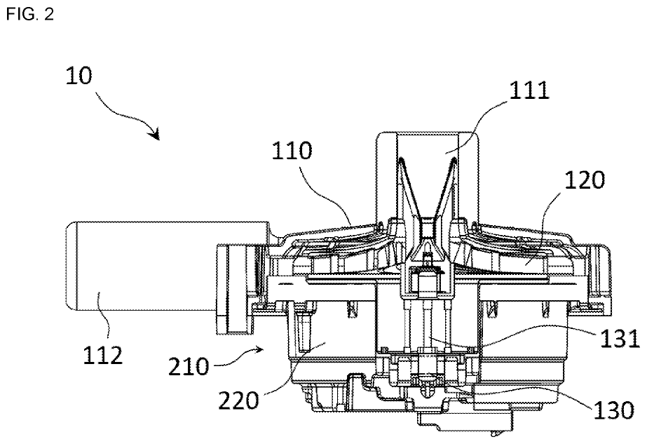

FIGS. 1 and 2 illustrate an overall configuration of an electric water pump 10 according to the present disclosure. As illustrated, the electric water pump 10 according to an embodiment of the present disclosure may broadly include an upper assembly 100 and a lower assembly 200 coupled to the upper assembly 100.

More specifically, the lower assembly 200 may include a stator assembly 210 forming a rotor accommodation portion 221 in which the upper assembly 100 is accommodated, and a molding portion 220 surrounding the stator assembly 210 to insulate the stator assembly 210, and the upper assembly 100 may include an upper casing 110, a rotor 130, and an impeller 120 rotating together with the rotor 130 to move fluid.

Here, the upper casing 110 may include an inlet 111 communicating from an upper portion to a central portion and an outlet 112 formed in a discharge direction of the impeller 120. The impeller 120 may rotate by the rotor 130 and form pressure to pump fluid from the inlet 111 to the outlet 112.

Further, the rotor 130 and a rotation shaft 131 may generate rotational force through magnetic force when current is applied to the stator assembly 210 according to a principle of an electric motor. The impeller 120 may extend from the rotor 130 and receive rotational force from the rotor 130 and the rotation shaft 131 to pump fluid as described above.

Referring to FIG. 2, as illustrated, the lower assembly 200 may include the stator assembly 210 and the molding portion 220. The stator assembly 210 may include the rotor accommodation portion 221 accommodating the rotor 130 and a plurality of coils 201 arranged around the rotation shaft 131 in a circumferential direction. The rotor accommodation portion 221 may be hollow and have a horizontal cross-section formed in a circular shape to allow rotation of the rotor 130.

Further, the molding portion 220 may be formed by injecting a molding member by performing over-molding surrounding the stator assembly 210 in all directions. The molding portion 220 may integrally waterproof configurations requiring insulation, such as the coil 201 included in the stator assembly 210, and may be injected to be compatible with the upper assembly 100.

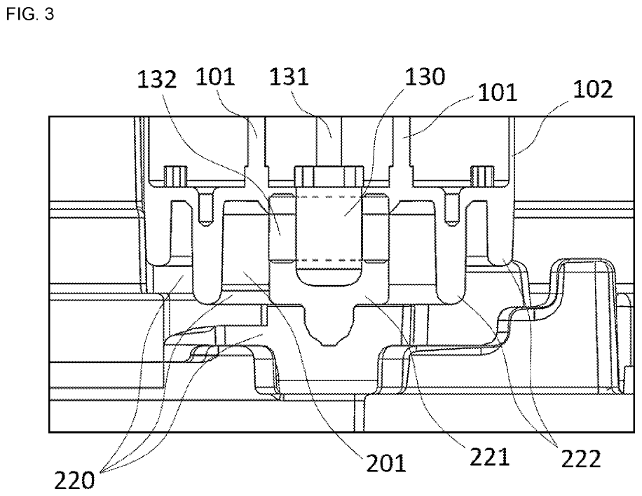

FIG. 3 illustrates a cross-section of the electric water pump 10 according to the present disclosure in a more enlarged manner. The stator assembly 210 may include the rotor accommodation portion 221 and the plurality of coils 201 arranged around the rotation shaft 131 in the circumferential direction. Here, the stator assembly 210 may form the molding portion 220 by injecting a molding member to insulate the plurality of coils 201 and integrate the stator assembly 210. Accordingly, the stator assembly 210 may form the rotor accommodation portion 221 inside the molding portion 220 surrounding the coils 201 and may form an outer accommodation portion 222 formed outside the molding portion 220 surrounding the coils 201.

Here, the rotor accommodation portion 221 may communicate with the impeller 120 to allow internal fluid to circulate inside the rotor accommodation portion 221 and around the molding portion 220. To this end, the upper assembly 100 may include a connection path 101 communicating with the lower assembly 200, and the connection path 101 may communicate with the impeller 120 and the interior of the stator assembly 210.

That is, liquid introduced through the inlet 111 may circulate by passing through the impeller 120 and the connection path 101 and through the rotor accommodation portion 221 and the outer accommodation portion 222.

Here, the electric water pump 10 may further include an outer flow path 102 in which the upper assembly 100 and the lower assembly 200 are coupled and a predetermined gap is formed. The outer flow path 102 may reduce friction between the upper assembly 100 and the lower assembly 200 and simultaneously function as a flow path through which internal fluid circulates.

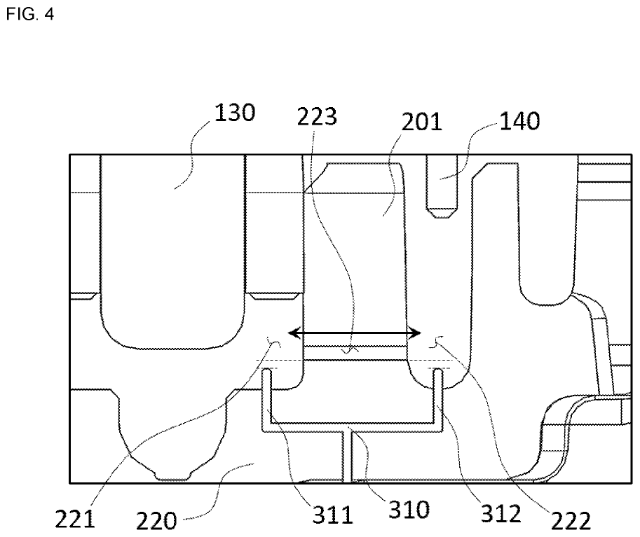

FIG. 4 illustrates the electric water pump 10 according to the present disclosure in a more enlarged manner, and as illustrated, the electric water pump 10 may include a grounding device 310 in contact with internal fluid and connected to the outside.

More specifically, the grounding device 310 may include one end interposed in the stator assembly 210 and the other end extending from the one end and connected to the outside. Here, the grounding device 310 may be molded together with the stator assembly 210 to integrate the grounding device 310 with the molding portion 220 and to ground the grounding device 310 to the outside through the terminal 300. That is, the grounding device 310 may be in contact with liquid circulating inside the stator assembly 210 to discharge internal electricity to the outside.

The stator assembly 210 may include the rotor accommodation portion 221 formed inside the molding portion 220 surrounding the coils 201 and the outer accommodation portion 222 formed outside the molding portion 220 surrounding the coils 201, and the grounding device 310 may be interposed in at least one of the rotor accommodation portion 221 and the outer accommodation portion 222.

Here, as illustrated, a plurality of outer accommodation portions 222 may be provided, and in a configuration of the rotor accommodation portion 221 and the plurality of outer accommodation portions 222, the molding portion 220 may form a plurality of partition walls and components requiring cooling such as the coils 201 may be disposed in each of the partition walls, thereby maximizing cooling efficiency.

For example, in the electric water pump 10 according to the present disclosure, the grounding device 310 may include a first grounding device 311 interposed in the rotor accommodation portion 221 and a second grounding device 312 interposed in the outer accommodation portion 222. This configuration may prevent insufficient contact for grounding occurring due to cavitation of liquid circulating inside the stator assembly 210 or the like.

Further, the lower assembly 200 may include the terminal 300 coupled to a lower portion of the stator assembly 210, electrically connected to the coils 201 and internal configurations, and integrally molded therewith by the molding portion 220, and the first grounding device 311 and the second grounding device 312 may be connected to the terminal 300 to be grounded to the outside.

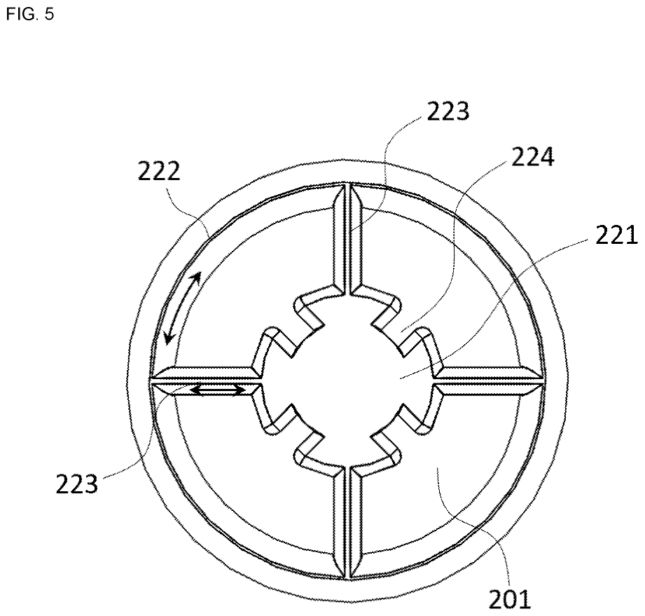

Here, referring to FIG. 5 together, as illustrated, the rotor accommodation portion 221 and the outer accommodation portion 222 positioned on both sides of the coil 201 may communicate with each other, and this configuration may be implemented by forming a passage 223 disposed between the coils 201 arranged in the circumferential direction.

For example, lower surfaces of the rotor accommodation portion 221 and the outer accommodation portion 222 positioned on both the sides of the coil 201 may each be lower than a lower surface of the passage 223. This configuration may prevent liquid circulating inside from receiving excessive resistance due to the grounding device 310 when the grounding device 310 is connected to the terminal 300 positioned at a lower end and protrudes upward from a lower end portion of the stator assembly to be interposed in the stator assembly 210.

Further, the first grounding device 311 and the second grounding device 312 may each be formed at a height lower than the lower surface of the passage 223 to further maximize the above-described effect.

Further, as illustrated, the upper assembly 100 may further include a downward protrusion 140 interposed in the outer accommodation portion 222 to a predetermined depth. The downward protrusion 140 may rotate together when the rotor 130 and the impeller 120 rotate, and may rotate inside the outer accommodation portion 222. This configuration may circulate liquid more smoothly inside the stator assembly 210 and provide an additional effect that liquid descends inside the outer accommodation portion 222 to allow the grounding device 310 and liquid to come into contact with each other more smoothly.

Further, as illustrated in FIG. 5, the molding portion 220 may include a seating portion 224 which protrudes toward an inner direction of the rotor accommodation portion 221 and on which a bearing 132 is seated.

Here, the seating portion 224 may be spaced apart from the passage 223. That is, the seating portion 224 may prevent the bearing 132 and the rotor 130 from excessively entering the rotor accommodation portion 221 and allow stable coupling, and may be arranged as such not to act as a resistance to liquid circulating inside.

The electric water pump according to the present disclosure may discharge internal electricity to the outside, which is caused by liquid circulating inside the stator assembly, and thus prevent adverse influence on the internal configurations due to electrical noise and internal current.

Further, the electric water pump according to the present disclosure may include the molding portion forming the plurality of partition walls inside the stator assembly and the plurality of grounding devices corresponding thereto, thereby maximizing cooling efficiency and grounding efficiency.

1. An electric water pump comprising:
an upper assembly including an impeller;
a lower assembly coupled to the upper assembly; and
wherein the lower assembly includes
a stator assembly including a rotor accommodation portion accommodating a rotor and a plurality of coils arranged around a rotation shaft of the rotor in a circumferential direction, and
a molding portion surrounding the stator assembly to insulate the plurality of coils,
wherein the rotor accommodation portion communicating with the impeller to allow internal fluid to circulate inside the rotor accommodation portion and around the molding portion,
the electric water pump further comprising a grounding device that is in contact with the internal fluid and is connected to an exterior.

2. The electric water pump of claim 1, wherein one end of the grounding device is interposed in the stator assembly.

3. The electric water pump of claim 2, wherein the grounding device is interposed in the stator assembly and protrudes upward from a lower end portion of the stator assembly.

4. The electric water pump of claim 3, wherein the stator assembly includes the rotor accommodation portion formed inside the molding portion surrounding the coils, and an outer accommodation portion formed outside the molding portion surrounding the coils, and the grounding device is interposed in at least one of the rotor accommodation portion and the outer accommodation portion.

5. The electric water pump of claim 4, wherein the grounding device includes a first grounding device interposed in the rotor accommodation portion, and a second grounding device interposed in the outer accommodation portion.

6. The electric water pump of claim 5, wherein the electric water pump includes a terminal coupled to a lower portion of the stator assembly and electrically connected to the coils, and the first grounding device and the second grounding device are connected to the terminal.

7. The electric water pump of claim 5, wherein the molding portion further includes a passage through which the rotor accommodation portion and the outer accommodation portion communicate with each other.

8. The electric water pump of claim 7, wherein the first grounding device and the second grounding device are each formed at a height lower than a lower surface of the passage.

9. The electric water pump of claim 7, wherein the molding portion includes a seating portion which protrudes toward an inner direction of the rotor accommodation portion and on which a bearing is seated, and the seating portion is spaced apart from the passage.

10. The electric water pump of claim 4, wherein the upper assembly further includes a downward protrusion interposed in the outer accommodation portion to a predetermined depth.
